(19) United States
(12) Patent Application Publication
(10) Pub. No.: US 2008/0116169 A1
(43) Pub. Date: May 22, 2008

(54) METHOD AND STRUCTURE OF PATTERN MASK FOR DRY ETCHING

(75) Inventors: Wen-Kun Yang, Hsin-Chu City (TW); Jui-Hsien Chang, Jhudong Township (TW); Chi-Chen Lee, Taipei City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Advanced Chip Engineering Technology Inc.

(21) Appl. No.: 11/837,738

(22) Filed: Aug. 13, 2007

Related U.S. Application Data
(62) Division of application No. 11/562,442, filed on Nov. 22, 2006.

(51) Int. Cl. C03C 25/68

(52) U.S. Cl. 216/47

(57) ABSTRACT

The present invention provides a structure for etching process. The structure has a mask for protecting an area of a wafer from being etched and a seal ring attached under a lower surface of the mask. The mask has at least one air opening to expose an area to be etched. Furthermore, the mask is attached on the wafer through the seal ring. In addition, the present invention provides also a method to form a mask for dry etching process. First, the present invention includes a step of providing a base material and coating the masking material on both sides of the base material. The next step is to pattern the masking material to form openings. Subsequently, the base material is etched through the openings to create at least one mask opening and a mask cavity. Finally, removing the mask material is performed.

### RELATED APPLICATIONS

This application is a divisional of U.S. application Ser. No. 11/562,442, filed Nov. 22, 2006.

### FIELD OF THE INVENTION

This invention relates to an etching method for package assembly, and particularly, to a method of dry etching with a pattern mask.

### BACKGROUND OF THE INVENTION

### Description of the Prior Art

In the process and manufacture of semiconductor, etching the thin films previously deposited and/or the substrate itself is necessary. In general, there are two classes of etching processes, wet etching and dry etching. Wet etching utilizes a chemical reaction processed between a film and specific chemical solution to remove the film uncovered by photo-resist. Because this etching method uses the chemical reaction to remove the film, the chemical reaction is not particular directional, so the method is so-called an isotropic etching. A disadvantage of wet etching is the undercutting caused by the isotropy of etching. Another, the dry etching employs plasma to remove the film, and the reaction is unconcerned with solution. The purpose of dry etching is to create an anisotropic etch—meaning that the etching is un-directional. An anisotropic etch is critical for high-fidelity pattern transfer.

The fluorine ions are accelerated by the electric field causing them to collide into the surface of the sample or the etching region, where they combine with silicon dioxide and then are dispersed. The phenomenon is Ion Bombardment. Because the electric field accelerates ions toward the surface, the etching caused by these ions is much more dominant than the etching of Radicals—ions traveling in varied directions, so the etching are anisotropic. In dry etching process, a hard mask is used to protect certain areas from etching, and to expose only the areas desired to be etched. Conventionally, RIE or plasma etching employs photo-resist as an etching pattern.

The etching for packaging assembly is quite different from the etching to the chips formation. A certain process maybe introduced to remove the native oxide formed on the metal pad. Typically, it is likely to remove the undesired material by wet etching when the wafer includes general silicon based device formed thereon. However, if a wafer or substrate is packaged with different species of devices, for example, one includes aluminum pad and other includes gold pad. As known, oxide is likely to be formed on the aluminum pad. Thus, an etching is necessary to remove the oxide formed thereon. However, a blanket etching or wet etching will damage the part of wafer without the oxide formation, for instance, the gold pad. The conventional method will cause the gold pad to be damage when the blank etching is performed for package assembly. In addition, increasing the quantity of output effectively is hard. What is desired is a new method for package assembly in order to overcome these problems.

### SUMMARY OF THE INVENTION

The present invention discloses a structure for etching, the structure comprise a mask for protecting an area of a wafer from being etched, wherein the mask has at least one air opening to expose an area to be etched; and a seal ring attached under a lower surface of the mask, wherein the mask is attached on the wafer through the seal ring.

Furthermore, the present invention discloses a structure for etching, the structure comprises a mask for protecting an area of a wafer from being etched, wherein the mask has at least one air opening to expose an area to be etched; and a cavity to expose a pixels array when the mask is attached to the wafer.

In addition, the present invention discloses a method to form etching mask, the method comprise the steps of providing a base material and coating a first masking material and a second masking material on both sides of the base material. The next step is to pattern the first masking material and the second masking material, thereby forming first openings within the first masking material and the second masking material, and a second opening within one of first masking material and the second masking material. Subsequently, the base material is etched through the first openings and second opening to create at least one mask opening and a mask cavity. Then, the first masking material and the second masking material is stripped.

An aspect of the present invention is to provide a pattern mask structure in dry etching process for packaging a wafer instead of an individual chip. The mask is attached on a wafer through spacer or seal ring, for exposing only the areas desired to be etched and protecting the wafer. There are no exposure or development steps needed for pattern mask. Therefore, the advantage of the present invention is to simplify etching process for improving the quantity of output effectively. In addition, this may further reduce the cost for manufacture.

Furthermore, another aspect of the present invention may be applied to the removal of layer, material formed on an area of signal die. This can control etching process on a particular area of a wafer so that avoid the other area on wafer being etched, whereby improving the process quality and accuracy. Furthermore, the material under removing is not limited to oxide, any undesired material could be removed by the present invention. For example, the present invention can be applied to remove unwanted area coating on a CMOS sensor.

Another aspect of the present invention is having spacer or seal ring formed between the mask and the wafer for reducing the possible that the mask contact with wafer directly, avoiding the surface on wafer being scraped by the mask. In this manner, the present invention can further improve the wafer quality in manufacture process. In addition, an advantage of present invention is to reduce the stress that the mask attached on the wafer because the material of the spacer or seal ring includes elastic material, absorbing indirectly the mechanical stress.

### BRIEF DESCRIPTION OF THE DRAWINGS

The above objects, and other features and advantages of the present invention will become more apparent after reading the following detailed description when taken in conjunction with the drawings, in which:

FIGS. 1-4 are across-sectional views of a dry etching process in accordance with the embodiment of the present invention.

FIG. 5 is an across-sectional view of a structure for the dry etching process in accordance with another embodiment of the present invention.

FIG. 6 is an across-sectional view of a structure for the dry etching process in accordance with another embodiment of the present invention.

FIGS. 7A-7D are flow charts for the mask making process about FIG. 6.

FIG. 8 is an across-sectional view of a structure for the dry etching process in accordance with another embodiment of the present invention.

### DESCRIPTION OF THE PREFERRED EMBODIMENT

The following embodiments and drawings thereof are described and illustrated in the specification that are meant to be exemplary and illustrative, not limiting in scope. One skilled in the relevant art will identify that the invention may be practiced without one or more of the specific details, not limiting in scope.

Referenced throughout the specification to “one embodiment” or “an embodiment” means that a particular feature, structure, or characteristic described in connection with the embodiment and included in at least one embodiment of the present invention. Thus, the appearances of the phrase “in one embodiment” or “in an embodiment” in various places throughout the specification are not necessarily all referring to the same embodiment. Furthermore, the particular features, structures, or characteristics may be combined in any suitable manner in one or more embodiments.

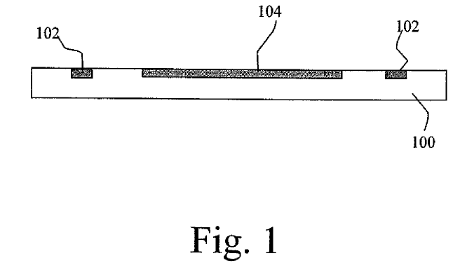

FIGS. 1-4 are across-sectional views of a dry etching process in accordance with the embodiment of the present invention, showing the serial steps of the process separately. Refer to FIG. 1, depicting an across-sectional view of pixels array 104 formed on a wafer 100 in accordance with the embodiment of the present invention. The bonding pads 102 material are selected according the type of application. For example, if the structure of FIG. 1 is used in image sensor application, typically, the material of pads 102 is metal such as Aluminum or the alloy. Metal oxide is likely to be formed on the surface of Aluminum pads 102. The native oxide must be removed by etching during the packaging assembly. As aforementioned, the blank etching and wet etching by conventional method will induce side effect.

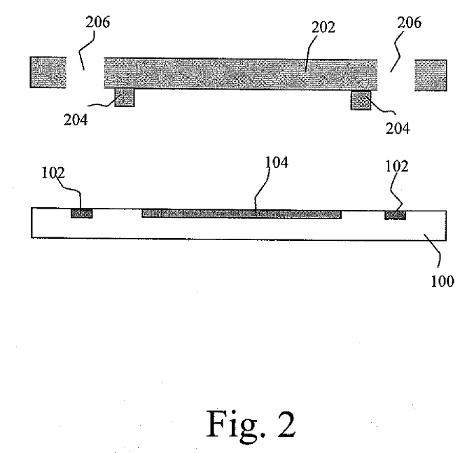

Thus, refer to FIG. 2, providing a mask 202 is introduced for protecting the pixel array (die) 104 formed on wafer 100 from being etched, wherein the mask 202 has at least one air opening 206 formed through the mask 202, alternatively, a non-conductive layer is coated on the mask 202. A seal ring 204 is subsequently attached to the lower surface of the mask 202. Preferably, the material of the seal ring 204 includes elastic, or insulating material including silicone resin, elastic PU, porous PU, acrylic rubber, blue tape or UV tape, polyimide (PI), polyester (PET), and polypropylene (BOPP). The seal ring 204 as a buffer film has the characteristics of viscosity or adhesive for attaching the mask 202 to the wafer 100, and the seal ring 204 is formed by a printing, coating, tapping or molding method. One purpose of the buffer film 204 is to prevent the wafer 100 from being scratched by the mask 202.

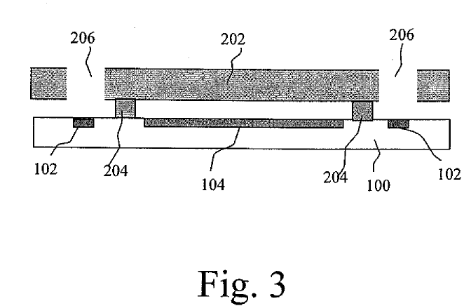

The mask 202 is attached on the upper surface of the wafer 100 through the seal ring 204 as shown in FIG. 3, wherein the mask 202 with the seal ring 204 has air openings 206 to expose an area formed on the wafer 100. In the embodiment of the present invention, the mask 202 exposes the aluminum pads 102. The seal ring 204 is formed between the mask 202 and the wafer 100, therefore the mask 202 is not attached to the wafer 100 directly for protecting the pixels array 104 on the wafer 100 and avoiding the pixels array 104 being scraped by the mask 202. Furthermore, the mask 202 can be used for protecting the surface of the area where is not desired to be etched. It should be noted that the mask 202 is different from the photo-mask for lithography. The ions may pass through the mask 202 via the air openings 206, not like the convention photo-mask, it includes transparent material aligned to the opening 206 to allow the illumination to pass through. The air openings 206 of the mask 202 are aligned to and expose the aluminum pads 102 in the embodiment of the present invention. In general, the conventional photo-mask is used to transfer the pattern thereon to a photo-resist on a wafer. However, the purpose of the mask is not. The material of the mask 202 could be conductive or non-conductive material.

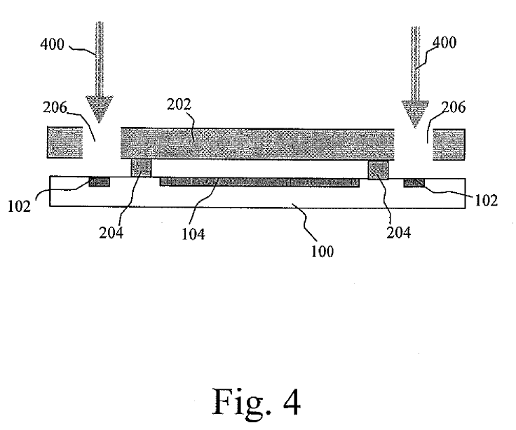

During dry etching, applying plasma 400 on the wafer 100 as shown in FIG. 4, for removing metal oxide on aluminum pads 102. Preferably, the dry etching is provided by RIE etcher, electron cyclotron resonance plasma, inductively coupled plasma etcher, helicon wave plasma etcher, or cluster plasma process. The mask 202 can be re-used for another wafer etching. The typically etching for IC formation, the photo-resist will be stripped after etching. Thus, the present invention is quite different form the conventional IC etching.

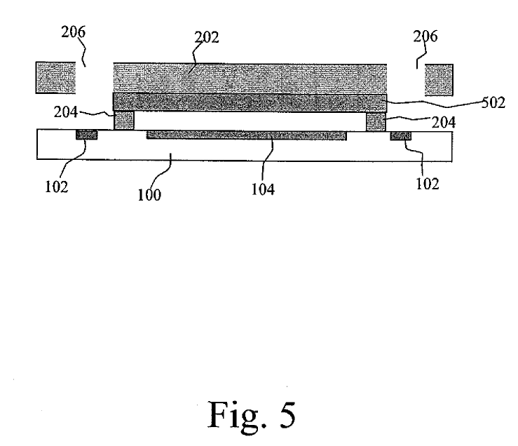

Alternatively, in accordance with another embodiment of the present invention, an across-sectional view of a structure for the dry etching process is shown in FIG. 5. It shows another mask design. A buffer layer 502 is attached between the mask 202 and the seal ring 204. The mask 202 has air openings 206 to expose the pads 102 formed on the wafer 100 through the seal ring and the buffer layer 502, subsequently, etching the metal oxide on the pads 102 through the openings 206 during dry etching process. Preferably, the material of the buffer layer 502 includes elastic material: silicone resin, elastic PU, porous PU, acrylic rubber, blue tape or UV tape, polyimide (PI), polyester (PET), and polypropylene (BOPP). The function of the buffer layer 502 is to further absorb the stress between the mask 202 and the wafer 100, in addition, it is employed to enhance the ability of protecting the pixels array 104.

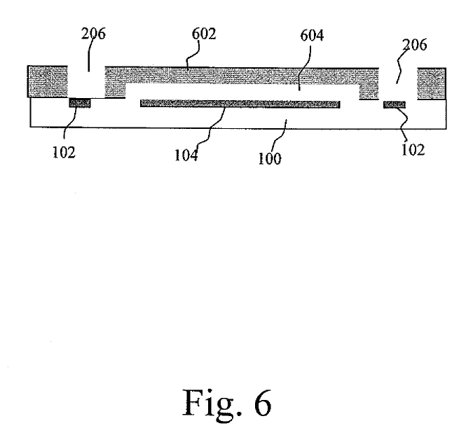

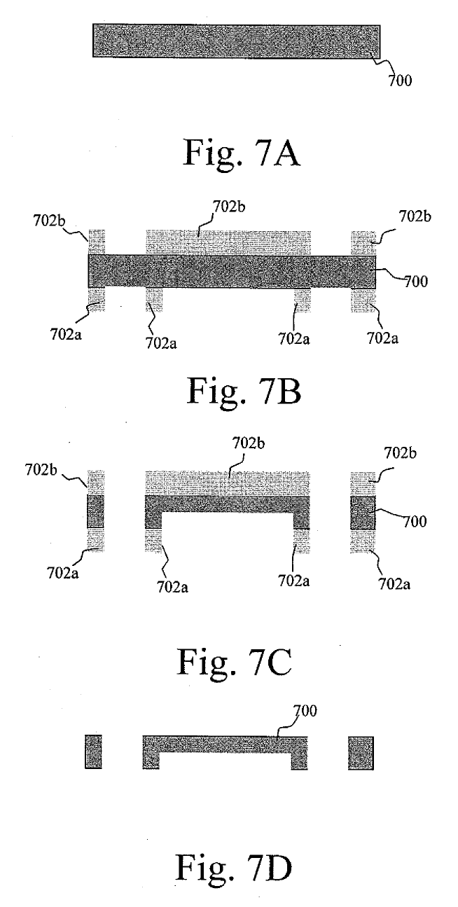

Alternatively, the present invention provides another mask design as shown in FIG. 6. It illustrates an across-sectional view of a structure for the dry etching process in accordance with another embodiment of the present invention. Carefully, the difference between the structures in FIG. 6 and above-mentioned examples of FIGS. 1-5, the mask 602 attaches directly to the wafer 100, and no buffer layer or seal ring is formed between the wafer 100 and the mask 602. It should be noted, the mask 602 includes a cavity 604 formed therein. The cavity 604 is formed on the surface that faces to the wafer 100, and the cavity 604 is aligned to the pixels array 104 of the wafer 100. When the mask 602 is directly attached on the wafer 100, the cavity 604 may prevent the mask 602 from contacting to the surface of the pixels array 104 of the wafer 100. The cavity is created by etching the mask 602, whereby the same feature and objects of above-mentioned examples can be achieved. The mask making process for the embodiment of FIG. 6 is shown from FIGS. 7A to 7D.

Refer to FIG. 7A, first, a mask material 700, for instance metal or alloy, is provided for forming the shape of the mask 602 as shown in FIG. 6. Photo-resists 702a, 702b are respectively coated on the double side of the material 700, and then an exposure step is performed to form the structure shown in FIG. 7B. It should be noted, the opening areas are exposed by the photo-resists 702a, 702b from both sides. The predetermined cavity area is exposed only by the photo-resist 702a. Namely, the material 700 surface that opposites to the cavity area is covered by the photo-resist 702b. Subsequently, an etching is performed to each the material 700 from double sides, thereby forming the structure as shown in FIG. 7C. Finally, the photo-resist 702a, 702b is stripped to form the shape of the mask 602 for FIG. 6.

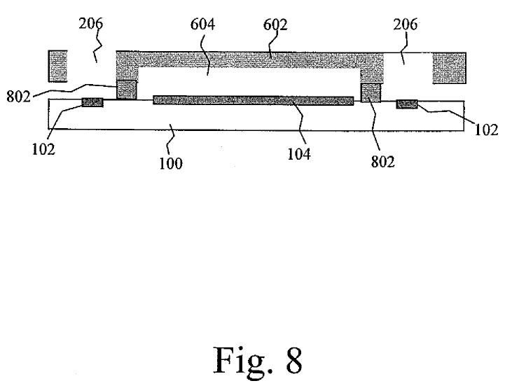

Alternatively, another mask design is shown in FIG. 8, it illustrated an across-sectional view of a structure in accordance with another embodiment of the present invention. The seal ring 802 is formed on the mask 602 with the cavity 604. Subsequently, the mask 602 is attached on the wafer 100 through the seal ring 802, for protecting the pixels array 104 on the wafer 100 from being etched during dry etching process, and avoiding the pixels array 104 being scraped by the mask 602. The mask 602 with the seal ring 802 has air openings 206 to expose the pads 102 formed on the wafer 100, followed by etching the metal oxide on the pads 102 with dry etching process. In addition, the seal ring 802 may absorb the stress between the mask 602 and the wafer 100. Preferably, the material of the seal ring 802 includes elastic material silicone resin, elastic PU, porous PU, acrylic rubber, blue tape, UV tape, polyimide (PI), polyester (PET), or polypropylene (BOPP).

Therefore, the present invention provides a method to remove undesired material for package. The area to be etched is exposed by the mask with air opening, and the residual area is protected by the mask.

Alternatively, the material under removing is not limited to oxide, any undesired material could be removed by the present invention. For example, in the application for CMOS sensor, the present invention can be applied to remove unwanted layer such as coating on the area except for the lens area.

It will be appreciated to those skilled in the art that the preceding examples and preferred embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention.

Having described the invention, the following is claimed:

1. A method to form etching mask, comprising:
providing a base material;
coating a first masking material and a second masking material on both sides of said base material;
patterning said first masking material and said second masking material, thereby forming first openings within said first masking material and said second masking material, and a second opening within one of first masking material and said second masking material;
etching said base material through said first openings and second opening to create at least one mask opening and a mask cavity;
removing said first masking material and said second masking material.

2. The method of claim 1, wherein said mask opening is aligned to pads of a wafer.

3. The method of claim 1, wherein said mask cavity is aligned to a pixels array of a wafer.
